(19) United States
(12) Patent Application Publication
(10) Pub. No.: US 2025/0184744 A1
(43) Pub. Date: Jun. 5, 2025

(54) METHOD FOR SELECTIVE DATA USE AND/OR DATA PROVISION BETWEEN A FIRST AND A SECOND PARTICIPANT

(71) Applicant: Robert Bosch GmbH, Stuttgart (DE)

(72) Inventors: Maike Massierer, Ludwigsburg (DE); Mohamed Abdelsalam, Stuttgart (DE); Priyadarshini Priyadarshini, Ludwigsburg (DE); Ralf Kible, Boeblingen (DE); Simon Greiner, Leonberg (DE)

(21) Appl. No.: 18/957,022

(22) Filed: Nov. 22, 2024

(30) Foreign Application Priority Data
Dec. 1, 2023 (DE) 10 2023 212 059.3

(51) Int. Cl. H04W 12/67; H04W 4/44; H04W 4/46

(52) U.S. Cl. CPC H04W 12/67; H04W 4/44; H04W 4/46

(57) ABSTRACT

A method for selective data use and/or data provision between a first and a second participant. An attack path to the first participant is determined by the first participant, which attack path has a first feasibility rating indicating the difficulty of the attack path and for which there is a security assumption about the second participant that, if not established, enables the attack path to the first participant. At least one attack path to the second participant is determined by the second participant, which attack path has a second feasibility rating indicating the difficulty of the attack path and breaches the security assumption. A risk function is determined by the first and/or the second participant. The first and/or the second participant, according to the risk value, provides data to the relevant other participant and/or uses data from the relevant other participant.

### CROSS REFERENCE

The present application claims the benefit under 35 U.S.C. § 119 of German Patent Application No. DE 10 2023 212 059.3 filed on Dec. 1, 2023, which is expressly incorporated herein by reference in its entirety.

### FIELD

The present invention relates to a method for selective data use and/or data provision between a first and a second participant, and to a computing unit and a computer program for carrying the method out.

### BACKGROUND INFORMATION

In the field of vehicles, in particular (semi-) autonomous vehicles, data can be communicated between vehicles (V2V: vehicle-to-vehicle) or between vehicles and infrastructure facilities (V2I: vehicle-to-infrastructure). In a vehicle, functionalities can be provided in a control unit or the like that determine and transmit such data or use the transmitted data.

### SUMMARY

According to the present invention, a method for selective data use and/or data provision between a first and a second participant and a computing unit and a computer program for carrying the method out are proved. Advantageous example embodiments of the present invention are disclosed herein.

According to the an example embodiment of the present invention, it is provided to determine attack paths to the first and the second participant that are connected via a security assumption which enables the attack path to the first participant and is breached by the attack path to the second participant. By means of a risk function, a risk value is determined from feasibility ratings for the attack paths and, based on the risk value, a provision of data to the relevant other participant is carried out and/or a use of data from the relevant other participant is carried out. As a result, it can be ensured that functionalities executed in one participant by executing computer programs, wherein the functionalities use data from the other participant or provide data to the other participant, do not have an undesired result or behavior that can occur due to manipulation by an attacker who at least partially succeeds in the overall attack path resulting from the combination of the attack paths to the first and second participant. Thus, the functionalities in the participants can be protected against manipulation.

A participant is understood to be a system (or a unit) that comprises at least one computing unit that executes at least one computer program to implement one or more functionalities of the participant. The (at least one) computer program uses data from another participant and/or provides data for the other participant. Data can be transmitted wirelessly by means of mobile radio, for example, in order to make them available.

The execution of the computer program and thus the implementation of functionalities are correspondingly dependent on this data. In particular, incorrect or manipulated data can lead to an undesirable result or behavior of the particular implemented functionality. Likewise, manipulated data (by an attacker) can lead to incorrect or manipulated data being provided.

An example of a participant is a vehicle or a control system of a vehicle that comprises at least one computing unit, such as a vehicle control unit, which implements the control functions of the vehicle and/or which detects or determines data relating to the vehicle (such as acceleration, speed, etc.) or which is detected by elements of the vehicle (such as camera or radar images, etc.). The control functions can use data from other participants and/or the detected or determined data can be provided to other participants. The control functions can be or include (partially) autonomous driving functions and/or assistance functions for a driver of the vehicle. In the case of two vehicles driving behind one another, the vehicle in front can provide acceleration and/or speed information or camera and/or radar images (i.e., sensor data) to the vehicle behind (by means of a corresponding functionality). This data can be used in the following vehicle by a distance keeping functionality or an overtaking assistance functionality.

Another example of a participant is an infrastructure facility, such as a traffic light, which (i.e., a control device contained therein) transmits status information, such as the switching status and/or switching times of the traffic light, as data to other participants, such as a vehicle. A further example of an infrastructure facility is a computer system or a server system, such as a so-called cloud service or an edge server, which determines and/or detects information (status information on a geographical area), such as the current and/or expected weather, road conditions or traffic density in certain stretches of road, etc., and transmits it as data to other participants.

According to one example embodiment of the present invention, the first participant or the second participant is a vehicle and the relevant other participant is an infrastructure facility. According to one embodiment, both the first and second participants are vehicles.

An attack on or attack path to a participant is generally understood to be a sequence of one or more steps that, when executed, causes a functionality implemented by the participant to produce undesired results or exhibit undesired behavior. A successful attack on a participant via an attack path can result in data detected and/or determined by this participant and transmitted to another participant being incorrect or manipulated. Such manipulation can occur directly in the participant, for example, if the attack targets the computer program or data used by it, or it can also affect the transmission path of data to other participants (for example, if a certificate or a secret key is read out and used to sign falsified data). On the other hand, the functionality implemented in a participant may be impaired if data provided by another participant and used by a computer program that implements the functionality is incorrect or manipulated (for example, as above, by an attacker signing the incorrect data with a stolen certificate or secret key).

In relation to the cooperation (data provision and/or data use) of two (or more) participants, e.g., participant A (first participant) and participant B (second participant), there is an attack path A to participant A, which is dependent on a security assumption relating to participant B, i.e., if the security assumption is not given, attack path A is enabled. In the example mentioned above, a security assumption is, for example, the trustworthiness of a signature. Furthermore, there is at least one attack path B to participant B that breaches the security assumption, i.e. that leads to the security assumption not being established. In the example mentioned above, attack path B is, for example, a reading out of the certificate or the secret key. In general, a security assumption can be breached by a plurality of attack paths B to participant B. For example, a facility in which the computing unit of participant B is located can be physically accessed (broken into) or remotely accessed in order to read out the certificate or the secret key. It is also possible that the certificate or the secret key could be read or intercepted during the programming of the computing unit of participant B (for example, during its production). The combination of attack path A and attack path B, which are related via the security assumption, can be regarded as an overall attack path.

According to an example embodiment of the present invention, tach attack path is assigned a rating (referred to as a feasibility rating) that indicates how difficult the attack path is to realize or carry out. Such a feasibility rating can, for example, be given as one or more numerical values (e.g., as an n-tuple), wherein different numerical values relate to different aspects of the carrying out. In particular, higher numerical values can correspond to an easier (for an attacker), successful carrying out of the particular aspect. Conversely, the feasibility rating can be regarded as a statement about the capabilities that an attacker must have in order to have a chance of successfully carrying out the attack path. The feasibility rating or different numerical values thereof relate in particular to different predetermined (e.g., according to a rating scheme) aspects of the participant that are relevant for attacks. Thus, from the knowledge of feasibility ratings for one or more attack paths, information about the internal structure of the participant and/or details of the implementation of functionalities of the participant and/or about possible vulnerabilities of the participant, such as certain aspects that can be attacked on a targeted basis, can be obtained.

In the event that a plurality of attack paths (with respective feasibility ratings) together form an overall attack path, a feasibility rating for the overall attack path can be determined from the feasibility ratings of the (plurality of) attack paths. If the feasibility ratings of the attack paths are given as n-tuples of numerical values, for example, the feasibility rating for the overall attack path can also be determined as an n-tuple, wherein the maximum or the sum of the corresponding numerical values of the feasibility ratings of the attack paths is used for each numerical value of the feasibility rating of the overall attack path. Of course, other mappings are also possible here (in addition to maximum selection and summation).

According to an example embodiment of the present invention, a so-called attack potential can be determined from the feasibility rating, wherein a high value in particular corresponds to easy feasibility of the attack path or low attacker capabilities. For example, the attack potential can be determined by a suitable function from the numerical values of the feasibility rating, in particular by forming the sum of the numerical values of the feasibility rating or by using the maximum numerical value of the feasibility rating as the attack potential, wherein other functions are also possible. If the feasibility rating is a single numerical value, this, e.g., can also be used directly as an attack potential (which is also a special case of the examples for functions mentioned above). In the event that a plurality of attack paths (with respective feasibility ratings) together form an overall attack path, the attack potential of the overall attack path can be determined directly or indirectly from the feasibility ratings of the plurality of attack paths. With a direct determination, the attack potential of the overall attack path is calculated by a suitable function that has the feasibility ratings of the plurality of attack paths as variables. With an indirect determination, the attack potential of the overall attack path is calculated from the feasibility rating of the overall attack path. The attack potential can be regarded as a summarized rating of the probability that the attack path or the overall attack path can be carried out successfully.

Furthermore, an attack path can be assigned an impact value, i.e. a value that indicates how great the (negative) impact of a successful carrying out of the attack path is on the functionality of the participant. The impact value indicates the extent to which the functionality of the participant is impaired if the attack path is successfully carried out. A higher impact value may correspond to a greater impact.

A risk or risk value can be determined from the attack potential and the impact value, which risk or risk value indicates the risk associated with the attack path. For this purpose, a risk function, which maps the impact value and the attack potential as variables on the risk value, can be used. In particular, the product of impact value and attack potential can be formed.

According to an example embodiment of the present invention, attack paths in two participants are connected via a security assumption as described, in order to obtain an overall attack path.

According to one example embodiment of the present invention, the evaluation of the risk function is carried out by the first and the second participant using a secure protocol for distributed computing. As a result, the aforementioned problem that if the feasibility ratings become known outside a participant, information about the participant can be obtained from the feasibility ratings of the participant and used for targeted attacks, is avoided. Thus, the functionality of the participant is additionally secured.

According to one example embodiment of the present invention, an impact value is determined for the attack path on the first participant and the risk function is still dependent on the impact value. As explained, the impact value indicates the extent to which the correct functionality of the participant is impaired if the attack path is successfully carried out.

According to one example embodiment of the present invention, if the risk value is above a predetermined risk threshold, the data from the relevant other participant are not used and/or data for the relevant other participant are not provided. This allows the setting of a desired level of protection by appropriately selecting the risk threshold.

According to one example embodiment of the present invention, the first and/or the second participant is a vehicle, wherein the one or more functionalities comprise one or more of: a semi-autonomous or autonomous driving function of the vehicle, assistance functions for a driver of the vehicle, transmitting status information of the vehicle to other vehicles, transmitting sensor data detected by sensors of the vehicle to other vehicles. Such functionalities, as well as the functionalities mentioned below in the case of an infrastructure facility, can lead to undesirable behavior if manipulated, which can result in, e.g., accidents.

According to one example embodiment of the present invention, the first or the second participant is an infrastructure facility, wherein the one or more functionalities comprise one or more of: transmitting a status of the infrastructure facility to vehicles, transmitting status information for a geographical area to vehicles located in that area.

The security assumption includes in particular the confidentiality of certain data, in particular a certificate and/or a secret key, and/or the authenticity of certain data.

A computing unit according to the present invention, e.g., a control unit of a motor vehicle, is configured, in particular in terms of programming, to carry out the steps of a method according to the present invention that relate to the first or the second participant.

Furthermore, the implementation of a method according to the present invention in the form of a computer program or computer program product having program code for carrying out the method steps of the present invention that affect the first or the second participant is advantageous because it is particularly low-cost, in particular if an executing control unit is also used for further tasks and is therefore present anyway. Finally, a machine-readable storage medium is provided having a computer program as described above stored thereon. Suitable storage media or data carriers for providing the computer program are, in particular, magnetic, optical, and electric storage media, such as hard disks, flash memory, EEPROMs, DVDs, and others. It is also possible to download a program via computer networks (Internet, intranet, etc.). Such a download can be wired or wireless (e.g., via a WLAN network or a 3G, 4G, 5G or 6G connection, etc.).

Further advantages and embodiments of the present invention can be found in the description herein and the FIGURE.

The present invention is shown schematically in the Figures on the basis of exemplary embodiments and is described below with reference to the FIGURE.

### BRIEF DESCRIPTION OF THE DRAWING

FIG. 1 shows a flowchart of a method for selective data use and/or data provision according to one example embodiment of the present invention.

### DETAILED DESCRIPTION OF EXAMPLE EMBODIMENTS

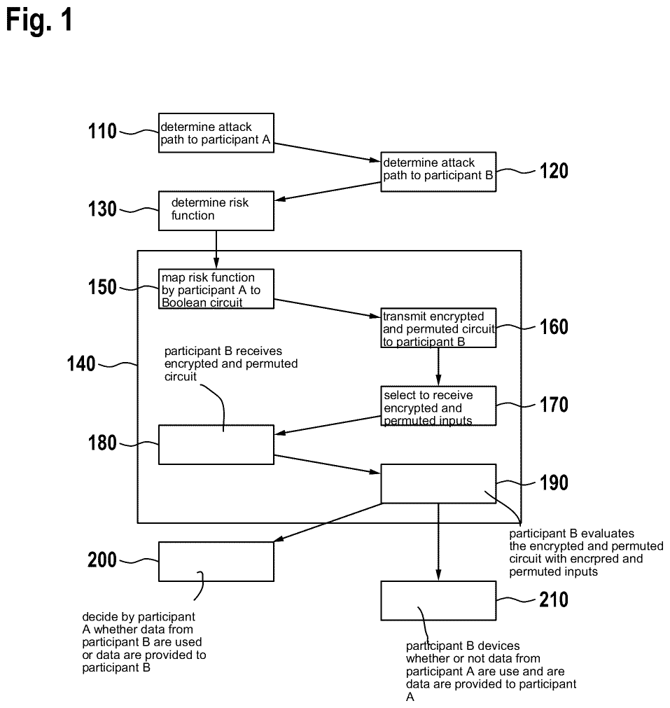

FIG. 1 shows a flowchart of a method for selective data use and/or data provision according to one embodiment of the present invention.

Two participants are involved in the method, i.e. a first participant, also referred to as participant A, and a second participant, also referred to as participant B. In FIG. 1, steps that are carried out by or affect participant A are shown on the left-hand side and steps that are carried out by or affect participant B are shown on the right-hand side.

Both participants in each case include a computing unit that implements one or more functionalities of the relevant participant by executing at least one computer program, wherein the one or more functionalities use data from the relevant other participant and/or provide data for the relevant other participant.

In step 110, at least one attack path A to participant A is determined or identified by participant A. Attack path A may already be known in participant A. Attack path A has a feasibility rating C_{A}. An impact value I_{A} of attack path A is also determined, or is known to participant A. For attack path A, there is also a security assumption L_{A}, which, if breached, enables the attack path A.

In step 120, at least one attack path B is determined or identified by participant B, which attack path breaches the security assumption L_{A} of attack path A. Participant A transmits the security assumption L_{A} to participant B. Attack path B also has a feasibility rating C_{B}.

In step 130, a risk function R is determined, which is a risk function of the attack paths combined via the security assumption L_{A} or the corresponding feasibility ratings C_{A} and C_{B} along with the impact value I_{A}. Thus, R=R (I_{A}, AP (C_{A} UND C_{B})), where AP is the attack potential of the overall attack path or the combination of attack paths A and B (symbolically referred to as C_{A} AND C_{B}). If the feasibility ratings C_{A} and C_{B} are given as n-tuples of numerical values (C_{Ai}, C_{Bi}), the attack potential of the overall attack path can be given approximately as AP (C_{A} UND C_{B})=Σᵢ max(C_{Ai}, C_{Bi}). Of course, other mappings of the feasibility ratings to the attack potential of the overall attack path are also possible.

In step 140, the risk function is evaluated, wherein, in particular, a secure protocol for distributed computing is used. The calculation of (at least) one risk value by means of the risk function is carried out in particular (when using the secure protocol for distributed computing) so that the feasibility ratings of one participant are not known to the relevant other participant. That is, the specific numerical values (C_{Ai} in the above example) of the feasibility ratings C_{A} of participant A are not known to participant B and the specific numerical values (C_{Bi} in the above example) of the feasibility ratings C_{B} of participant B are not known to participant A. This avoids the aforementioned problem that the feasibility ratings of a participant can be used to obtain internal information about this participant that can be used for targeted attacks.

In FIG. 1, the “garbled circuit” method, which is known to a person skilled in the art as a secure protocol for distributed computing, is shown as an example (steps 150 to 190, which together represent an exemplary implementation of step 140). Of course, another secure protocol for distributed computing can also be used.

In step 150, the risk function is mapped by participant A to a Boolean circuit, which is encrypted and randomly permuted (“garbled”). In the process, participant A maps the inputs and outputs or the corresponding values that they can assume to encrypted values (e.g., replaced by other values in a random manner) in relation to a truth table of the Boolean circuit and then randomly permutes the entries (rows) of the truth table. This encryption and permutation is only known to participant A.

In step 160, the encrypted and permuted circuit is transmitted, along with the corresponding encrypted and permuted inputs of attack path A (i.e., the encrypted and permuted values of impact value I_{A} and the feasibility rating C_{A} or C_{Ai} for attack path A), to participant B which, according to the security assumption, determines attack path B or the feasibility ratings C_{B} or C_{Bi} for attack path B.

In steps 170 and 180, a so-called “oblivious transfer” understood to a person skilled in the art is carried out, i.e. the encrypted and permuted inputs of attack path B (i.e., the encrypted and permuted values of the feasibility rating C_{B} or C_{Bi} for attack path B) are transmitted from participant A to participant B without participant A becoming aware of the actual feasibility rating of attack path B (which should only be known to participant B) and without participant B becoming aware of the encryption and permutation of the inputs (which should only be known to participant A). In step 170, a selection is made by participant B for the encrypted and permuted inputs to be received in accordance with the feasibility rating C_{B} or C_{Bi} and transmitted to participant A. Participant A then transmits the encrypted and permuted entries that correspond to this selection to participant B.

In step 190, participant B evaluates the encrypted and permuted circuit with the encrypted and permuted inputs received from participant A in step 180 (for the feasibility rating C_{B} or C_{Bi}), in order to determine the risk value. Since the output of this evaluation is also initially encrypted and permuted, participant B can query the assignment of the encrypted and permuted output to the actual risk value of participant A (e.g., via oblivious transfer). Alternatively or additionally, participant B can transmit the encrypted and permuted output to participant A, who then determines the risk value and transmits it to participant B if applicable. Likewise, an evaluation of the encrypted and permuted circuit by oblivious transfer A is possible, i.e. step 190 can also be carried out by participant A.

Depending on the risk value determined in step 140, it is decided in step 200 by participant A whether or not data from participant B are used and/or data are provided to participant B by a functionality of participant A that is potentially affected by attack path A. In particular, the functionality (of participant A) may not use data from participant B and/or does not provide data to participant B if the risk value is above a predetermined risk threshold. If the risk value is below the predetermined risk threshold, due to the functionality, data from participant B are used and/or data are provided to participant B. Different risk thresholds can be provided for different functionalities.

Analogous to step 200, in step 210 participant B can decide, according to the risk value, whether or not data from participant A are used and/or data are provided to participant A by a functionality of participant B.

The application of the present invention is illustrated below based on examples.

One example relates to communication between a vehicle (participant A) and an infrastructure facility (participant B). The system consists of an intelligent traffic light that sends its current status (red, yellow, green) to vehicles in its vicinity, and an autonomous vehicle that makes driving decisions (stop at a red light, cross the intersection, drive carefully through the intersection) according to the status of the traffic light. In order to ensure that the traffic light status received by the vehicle is actually sent by the traffic light, the message sent by the traffic light is cryptographically signed and the vehicle checks whether the signature is valid before the traffic light status is used by the vehicle.

An (incomplete) attack path on the vehicle or on the vehicle is as follows: generating a falsified traffic light message, signing the falsified message with a stolen certificate, sending the falsified and signed message to nearby vehicles. The feasibility rating of this attack path is given, e.g., by 5 numerical values: (1, 3, 0, 2, 4). The security assumption on the vehicle is the confidentiality of the certificate. The impact value is approximately 4. The scales for the feasibility rating and the impact value range from 0 to 5, for example.

A (marked) attack path on the traffic light that breaches the security assumption (confidentiality of the certificate) is as follows: attaching the device to the maintenance interface of the traffic light, executing a script to read out the firmware from the traffic light controller, extracting the certificate from the firmware. The feasibility rating of this attack path is, e.g.: (1, 3, 0, 5, 4).

If the vehicle approaches the traffic light, the method according to the present invention is carried out between the vehicle and the traffic light. As a result, the vehicle (i.e., a control device included in it) knows that the risk associated with communicating with the traffic light is R(4, (1+3+0+5+4))=R(4, 13)=“high” (approximately 4.13). The vehicle is designed such that it does not take any risks higher than “low” (for example, a risk threshold could be in the range of 10 to 20). Therefore, the vehicle does not use the messages (data provided) from the traffic light. As a result, the functionality “Crossing the intersection with the assistance of an intelligent traffic light” is deactivated and the vehicle only uses the sensors in the vehicle to cross the intersection if possi″le.

Another example relates to the situation where a vehicle (participant B) is following a truck (participant A). In order to assist overtaking maneuvers if the view of what is happening in front of the truck is restricted for the following vehicle, the truck sends images of the scene in front of the truck to the following vehicle in real time, based on wireless communication. The vehicle displays these images on the dashboard for the driver of the following vehicle to help him make the overtaking decision. In order to ensure that the images cannot be read by bystanders and thus potentially violate the privacy of road users and personal data, communication between the truck and the vehicle is encrypted.

One attack path on the truck is as follows: requesting from the truck images of the surrounding area. The feasibility rating of the attack path on the truck is, e.g.: (1, 0, 0, 2, 4). The security assumption on the truck is the confidentiality of personal data. The impact value is approximately 4.

The attack path on the vehicle that breaches the security assumption (confidentiality of personal data) is as follows: connection to the image storage device in the vehicle, reading out the decrypted images from the vehicle memory, with feasibility rating: (1, 0, 0, 0, 0).

If the vehicle requests the images from the truck to assist the overtaking maneuver, the method according to the present invention is carried out. As a result, the truck knows that the risk R(4, (1+0+0+2+4))=R(4, 7)=“very high”. The truck is designed such that it does not take a higher risk than “low” and therefore refuses to send the images to the following vehicle. The messages with the images are not sent to the following vehicle. For example, the following vehicle displays “Overtaking assistance not available” to the driver of the vehicle.

What is claimed is:

1. A method for selective data use and/or data provision between a first participate and a second participant, each participant of the first and second participants including a computing unit which implements one or more functionalities of the participant by executing at least one computer program, wherein the one or more functionalities use data from the relevant other participant and/or provide data for the other participant, the method comprising:
determining by the first participant an attack path to the first participant, the attack path to the first participant having a first feasibility rating indicating a difficulty of the attack path to the first participant and for which there is a security assumption about the second participant that, when not established, enables the attack path to the first participant;
determining by the second participant at least one attack path to the second participant, the attack path to the second participant having a second feasibility rating indicating a difficulty of the attack path to the second participant and breaches the security assumption;
determining a risk function by the first and/or the second participant, the risk function being dependent on the first feasibility rating and the at least one second feasibility rating;
evaluating the risk function by the first and/or the second participant to calculate a risk value;
providing by the first and/or the second participant, according to the risk value, data to the relevant other participant and/or using data by the first and/or the second participate from the other participant of the first and second participant according to the risk value.

2. The method according to claim 1, wherein the evaluation of the risk function by the first and the second participant is carried out using a secure distributed computing protocol.

3. The method according to claim 1, wherein an impact value is determined for the attack path to the first participant and the risk function is still dependent on the impact value.

4. The method according to claim 1, wherein, when the risk value is above a predetermined risk threshold, the data of the other participant are not used and/or data for the other participant are not provided.

5. The method according to claim 1, wherein the first and/or the second participant is a vehicle, and wherein the one or more functionalities include one or more of: a semi-autonomous or autonomous driving function of the vehicle, assistance functions for a driver of the vehicle, transmitting status information of the vehicle to other vehicles, transmitting sensor data detected by sensors of the vehicle to other vehicles.

6. The method according to claim 1, wherein the first participant or the second participant is an infrastructure facility, and wherein the one or more functionalities include one or more of: transmitting a status of the infrastructure facility to vehicles, transmitting status information for a geographical area to vehicles located in that area.

7. The method according to claim 1, wherein the security assumption includes a confidentiality of certain data, including a certificate and/or a secret key, and/or authenticity of certain data.

8. The method according to claim 1, wherein the first participant and/or the second participant is a vehicle.

9. A computing unit for selective data use and/or data provision between a first participate and a second participant, each participant of the first and second participants including a computing unit which implements one or more functionalities of the participant by executing at least one computer program, wherein the one or more functionalities use data from the relevant other participant and/or provide data for the other participant, the computing unit configured to:
determine by the first participant an attack path to the first participant, the attack path to the first participant having a first feasibility rating indicating a difficulty of the attack path to the first participant and for which there is a security assumption about the second participant that, when not established, enables the attack path to the first participant;
determine by the second participant at least one attack path to the second participant, the attack path to the second participant having a second feasibility rating indicating a difficulty of the attack path to the second participant and breaches the security assumption;
determine a risk function by the first and/or the second participant, the risk function being dependent on the first feasibility rating and the at least one second feasibility rating;
evaluate the risk function by the first and/or the second participant to calculate a risk value;
provide by the first and/or the second participant, according to the risk value, data to the relevant other participant and/or using data by the first and/or the second participate from the other participant of the first and second participant according to the risk value.

10. A non-transitory machine-readable storage medium on which is stored a computer program for selective data use and/or data provision between a first participate and a second participant, each participant of the first and second participants including a computing unit which implements one or more functionalities of the participant by executing at least one computer program, wherein the one or more functionalities use data from the relevant other participant and/or provide data for the other participant, the method comprising:
determining by the first participant an attack path to the first participant, the attack path to the first participant having a first feasibility rating indicating a difficulty of the attack path to the first participant and for which there is a security assumption about the second participant that, when not established, enables the attack path to the first participant;
determining by the second participant at least one attack path to the second participant, the attack path to the second participant having a second feasibility rating indicating a difficulty of the attack path to the second participant and breaches the security assumption;
determining a risk function by the first and/or the second participant, the risk function being dependent on the first feasibility rating and the at least one second feasibility rating;
evaluating the risk function by the first and/or the second participant to calculate a risk value;
providing by the first and/or the second participant, according to the risk value, data to the relevant other participant and/or using data by the first and/or the second participate from the other participant of the first and second participant according to the risk value.
